(19) United States
(12) Patent Application Publication
(10) Pub. No.: US 2008/0120541 A1
(43) Pub. Date: May 22, 2008

(54) SYSTEM AND METHOD FOR ON-LINE RETRIEVAL AND TYPING OF NON-STANDARD CHARACTERS

(75) Inventor: Kuo-Young Cheng, Taichung Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: DYNACOMWARE TAIWAN INC., Taipei (TW)

(21) Appl. No.: 11/562,917

(22) Filed: Nov. 22, 2006

(51) Int. Cl. G06F 17/20; G06F 17/00

(52) U.S. Cl. 715/269

(57) ABSTRACT

A network-based system and method are provided for permitting a user of a client computer to type in non-standard characters, i.e., characters that are not supported by the client computer. When a user downloads a Web font document from a Web server onto the user's client computer and requests to type in a non-standard character, the client computer receives a file including an emulated keyboard from a Web font server for display. The user then types in a non-standard character code corresponding to the desired non-standard character using the emulated keyboard. The Web font server receives the user-input non-standard character code, identifies one or more non-standard characters stored in a database that correspond to the received user-input non-standard character code, and creates and sends a file including the one or more identified non-standard characters back to the client computer for display.

### FIELD OF THE INVENTION

The present invention relates to the art of Asian character processing and, more particularly, to a system and method that permit a browser to retrieve non-standard characters on-line such that a browser can create a Web font document including non-standard characters or can use a non-standard character as a keyword in a search for relevant Web font documents.

### BACKGROUND

Web information available on the Internet is displayed on a client system via a Web browser operating on the client system. Typically, a client computer user accesses Web information by directly entering a URL (Uniform Resource Locator) of a desired Web page into the browser, or by using a search engine to locate several Web pages of interest and selecting one of them, or by moving and clicking a mouse on a hyperlink to the URL displayed on a screen. The browser will then download a Web page from the specified URL and display the Web page on the computer screen.

A Web page, or an electronic document available on the World Wide Web forming part of the Internet, is in hypertext markup language (HTML) format. The World Wide Web consists of numerous computer servers (or Web servers, or “sites”) on the Internet, where each Web server stores HTML documents that can be accessed by client computers on the Internet.

An HTML document generally includes text (defined with character codes), HTML tags that specify formatting and appearance of the text, links (or hyperlinks) to related HTML documents, and other files that may contain, for example, sound, image, video, etc. For example, HTML tags may specify a particular font in which text in the document is to be displayed. A font is a collection of characters and symbols that share a common design. In general, a font has three design elements: font face, style, and size. The font face of a font refers to specific visual characteristics of characters and symbols in the font such as the width or curve of strokes that form a character. Style refers to the weight (e.g., in bold) and slant (e.g., in italic) of a font. Size generally refers to the height of the characters in a font.

Generally, display of an Asian font on a computer screen is based on a font face (and style and size) and a character code. A character code, typically an alpha-numeric code, is assigned to each character within a font. Examples of character code sets include JIS code, Shift JIS code, Unicode, and ECU code. When a client computer receives a Web page document including Asian characters, each character is associated with a character code and a font face (and style and size).

When a Web browser retrieves an HTML document, it interprets the text based on character codes, and further interprets the HTML tags to identify a font face, style, and size with which characters in the document are to be displayed. A client computer on which the browser is operating, however, can support and display a particular character and/or font face only if that character and/or font face is registered or installed in the client computer. While many standard characters and/or font faces are registered in many client computers, other non-standard (or unique) characters and/or font faces are not, and also, the characters and/or font faces that are registered at different client computers vary widely. Thus, if a particular character and/or font face designated in an HTML document is not supported by a client computer receiving the HTML document, the client computer cannot display the document with the original character and/or font face.

Typically, when a client computer does not support a font face designated in an HTML document, the browser operating thereon selects a default font face and replaces the designated font face with the default font face. This is undesirable as it causes the appearance of a Web page to differ from what was intended by its author. Further, if the client computer does not support an individual character designated in an HTML document (i.e., if it does not recognize the character code for that character), then the client computer cannot even replace the unsupported character with a default character and therefore displays no character at all. This problem is more serious with Asian language Web pages because there are more characters (over 13,000 characters may be contained in a single font) and also more variations and types of font faces in Asian languages than in Roman-based languages.

To solve the problem above and provide other advantages, a system and method for providing Asian Web Font documents have been proposed, as disclosed in co-assigned and co-pending U.S. patent application Ser. No. 11/388,715, filed Mar. 24, 2006 (hereinafter “the '715 application”), the entire content of which is explicitly incorporated herein by reference.

Briefly, the '715 application discloses a network-based method for constructing a “Web font document” based on an Asian Web page document. The method includes generally five steps: (1) receiving an Asian Web page document in an HTML file from a Web server; (2) extracting font data from the received Asian Web page document, wherein the font data include a character code and a name of a font face for each character included in the Asian Web page document; (3) replacing each character in the received Asian Web page document with a Web font character, wherein the Web font character is defined by a character code, a name of a Web font face, and a Uniform Resource Locator (URL) of the Web font face on a network; (4) creating a Web font document in an HTML file; and (5) sending the created Web font document to the Web server to replace the Asian Web page document at the Web server with the created Web font document.

Web font characters that are used to replace the original characters in an Asian Web page document may be predefined and stored in one or more searchable databases, or may be generated anew based on images of the characters. For example, a new Web font character may be generated in terms of explicit parameters, such as key points and width values, and implicit parameters that are defined based on the explicit parameters, such as feature points and curve ratios, which together describe a shape of the received image of the character.

The '715 application also discloses a corresponding system for providing Asian Web font documents, which includes: (a) a Web server connected to a network and supporting an Asian Web page document; and (b) a Web font server connected to the network for constructing a Web font document based on an Asian Web page document received from a Web server, with a Web font database including Web font characters.

The '715 application further discloses a Web browser program for browsing Asian Web font documents, including generally four means: (1) means for receiving a user request to view an Asian Web font document at a particular Uniform Resource Locator (URL); (2) means for receiving an Asian Web font document in an HTML file from a Web server corresponding to the particular URL; (3) means for decoding the received HTML file to identify the name of a Web font face, the URL of the Web font face, and the character code for each Web font character included in the Asian Web font document; and (4) means for displaying the Asian Web font document by rendering each Web font character according to the corresponding name of a Web font face, the URL of the Web font face, and the character code.

While the invention described in the '715 application permits users to view Asian Web page documents in their original form (i.e., with the original characters in their original font face) through the use of Asian Web font documents, it remains that users cannot type non-standard characters that are not supported by their client computers. This creates a problem because numerous non-standard characters exist in the Asian languages, due to the fact that an Asian character is typically composed of some basic ideographical symbols, which can be freely combined to create a new character with a new meaning. For example, in the Asian languages, personal names often consist of non-standard characters, and many users cannot type in their personal names in Web font documents because their names include one or more non-standard characters unsupported by their client computers. As another example, a user cannot type in a keyword including any non-standard characters in an on-line search to locate related Web font documents based on the keyword.

A need exists for a system and method that enhance the capability of the previous browser program proposed in the '715 application. Specifically, a need exists for a system and method that permit users of client computers to not only browse and view Asian language Web pages including non-standard characters but also to type in non-standard characters.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present invention, a network-based method is provided for permitting a user of a client computer to type in a non-standard character in a downloaded Web font document. The method includes generally five steps: (a) receiving a user request to type in a non-standard character in a Web font document downloaded to the user's client computer; (b) sending a user-interface display file including an emulated keyboard to the client computer; (c) receiving a user-input non-standard character code that has been entered by the user via the emulated keyboard; (d) identifying one or more non-standard characters corresponding to the user-input non-standard character code; and (e) including the one or more non-standard characters in a file and sending the file to the client computer for display.

In accordance with some aspects of the present invention, the emulated keyboard is based on a phonetic input method, such as the Chinese phonetic input method. In this connection, the user-input non-standard character code may be a phonetic character code.

In accordance with another aspect of the present invention, the method includes the further steps of: (f) receiving a user selection of one of the one or more non-standard characters displayed on the client computer; and (g) causing the client computer to display the user-selected non-standard character.

In accordance with another embodiment of the present invention, a computer-readable tangible medium is provided including computer-executable instructions which, when loaded onto a Web font server, cause the Web font server to generally perform the method summarized above.

In accordance with yet another embodiment of the present invention, a network-based system is provided for permitting a user of a client computer to type in a non-standard character in a downloaded Web font document. The system includes generally two elements: (a) a Web server which is connected to a network and is supporting a Web font document; and (b) a Web font server connected to the network for permitting a user of a client computer to type in a non-standard character in a Web font document downloaded from the Web server. The Web font server includes or is connected to a Web font database including Web font characters, and further includes: (i) means for receiving a user request to type in a non-standard character in a Web font document downloaded to the user's client computer; (ii) means for sending a user-interface display file, including an emulated keyboard, to the client computer; (iii) means for receiving a user-input non-standard character code that has been entered by the user via the emulated keyboard; (iv) means for identifying one or more non-standard characters in the Web font database which correspond to the user-input non-standard character code; and (v) means for including the one or more non-standard characters in a file and sending the file to the client computer for display.

In accordance with a still further embodiment of the present invention, a computer-readable tangible medium including a computer-executable browser program is provided for permitting a user of a client computer, on which the browser program is operating, to type in a non-standard character in a downloaded Web font document. The browser program includes: (a) means for receiving a user request to enter a non-standard character and sending the request to a Web font server; (b) means for interpreting a user-interface display file including an emulated keyboard received from the Web font server and displaying the emulated keyboard on the client computer; (c) means for receiving a user-input non-standard character code via the displayed emulated keyboard; (d) means for sending the user-input non-standard character code to the Web font server; and (e) means for receiving one or more non-standard characters corresponding to the user-input non-standard character code from the Web font server and displaying the same on the client computer.

In accordance with a further aspect of the present invention, the browser program includes: (f) means for receiving a user selection of one of the one or more non-standard characters displayed on the client computer; and (g) means for displaying the user-selected non-standard character on the client computer.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a sample arrangement of a Web font server, a Web server, and a client computer, which allows the client computer to retrieve non-standard Asian characters online from the Web font server so that a user of the client computer can type in and display the non-standard Asian characters on the client computer;

FIG. 2 shows a sample Web font file management system included in the Web font server of FIG. 1, which generally performs the process of permitting the client computer to retrieve non-standard characters from the Web font server;

FIG. 3 is a flowchart illustrating a sample process to be generally performed by the Web font file management system of FIG. 2;

FIG. 4 is a sample Web font document, which prompts a user to type in his/her name in Asian characters;

FIG. 5 is a sample display of an emulated keyboard together with candidate characters returned in response to the user input of a non-standard character code, in the foreground, placed over the Web font document of FIG. 4 in the background;

FIG. 6 shows the sample Web font document of FIG. 4, wherein the user has completed typing in his/her name in Asian characters;

FIG. 7 is a flowchart illustrating a sample process to be generally performed by the Web font file management system of FIG. 2, to permit a user of the client computer to input a non-standard character code for a non-standard character using the Chinese phonetic input method;

FIG. 8 is a sample screen display that receives non-standard Asian characters in a keyword for conducting a search to retrieve related Web font documents;

FIG. 9 is a flowchart illustrating a sample process to be performed by a browser program operating in a client computer for browsing Web font documents and for permitting a user to type in non-standard Asian characters; and

FIGS. 10A-10C are sample HTML files, which are created during various processes in connection with the sample Web font documents shown in FIGS. 4-6, respectively.

### DETAILED DESCRIPTION

According to a method and system of the present invention, a Web browser operating on a client computer permits a user to type in and display non-standard characters (e.g., Asian characters) that are not supported by the client computer. As used herein, a non-standard character means a character that is not fully (in terms of both character codes and font faces) supported by a particular client computer, and thus is used as a relative term (i.e., some “non-standard” characters with respect to one client computer may be fully supported by another client computer and thus may not be “non-standard” with respect to that other client computer). In various exemplary embodiments, the invention achieves this goal by permitting the client computer to retrieve on-line and display an emulated keyboard, which the user can use to input non-standard character codes. The user-input non-standard character codes are then used to further retrieve on-line and display corresponding non-standard characters. The emulated keyboard and non-standard characters may be stored in a Web font server system according to various embodiments of the present invention. Thus, the user of the browser can type in non-standard characters to thereby create a Web font document including non-standard characters, or can type in a non-standard character as a keyword in a search engine to locate Web font documents containing the non-standard character.

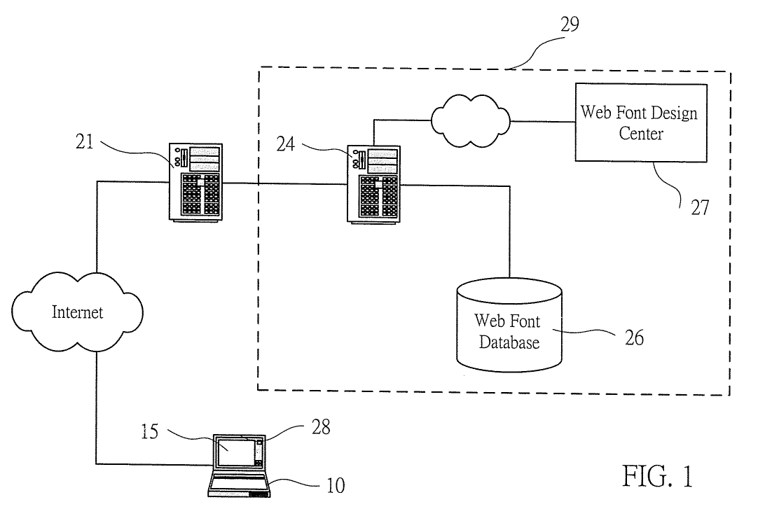

FIG. 1 illustrates an overall system for permitting a client computer (or a browser operating thereon) to retrieve non-standard characters on-line, according to one embodiment of the present invention. The system includes a client computer 10 including a display 15, on which a Web font browser 28 is operating, and a Web server 21 supporting an Asian language Web page, which are both connected to the Internet. The system further includes a Web font server 24 connected to the Internet, which performs the function of constructing a Web font document based on an Asian Web page document received from the Web server 21, as disclosed in the '715 application. The constructed Web font document is then stored in the Web server 21 in place of the original Asian Web page document. The Web font server 24 includes or is coupled to (via a public or private data network) a Web font database 26 including Web font characters, and a Web font design center 27, to together form a Web font server system 29. Briefly, the Web font design center computer 27 is provided to retrieve or create a non-standard Web font character and send it to the Web font server 24 if the Web font server 24 cannot find a desired Web font character in the Web font database 26.

The Web font server system 29 additionally performs the function of permitting the client Web font browser 28 to retrieve non-standard characters, such that the user of the Web font browser 28 can type in the retrieved non-standard characters on the client computer 10 even when the non-standard characters are not supported by the client computer 10. To that end, when the Web font browser 28 requests to view an Asian Web font document at the Web server 21, the Web font server 24 essentially intercepts the request and performs various processing to permit the user to type in non-standard characters in the Asian Web font document.

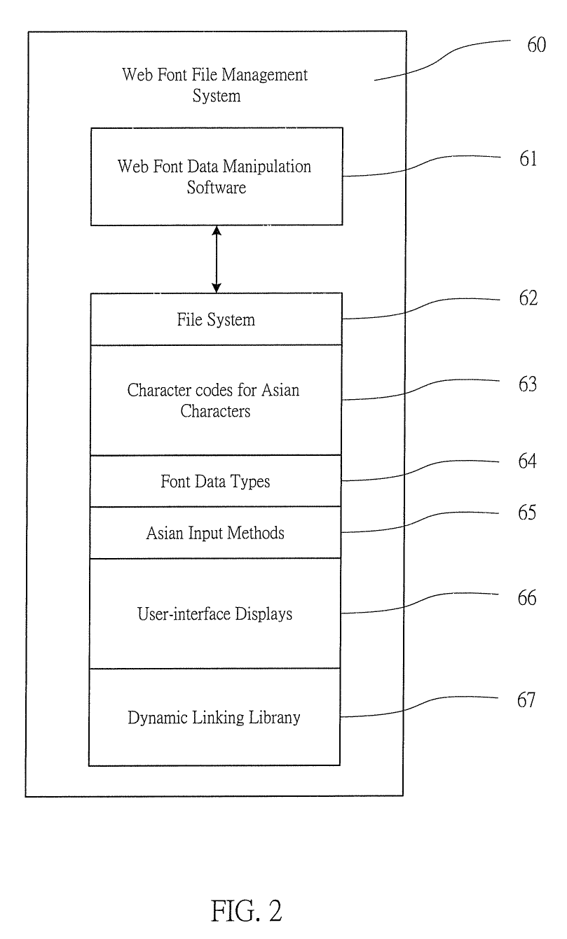

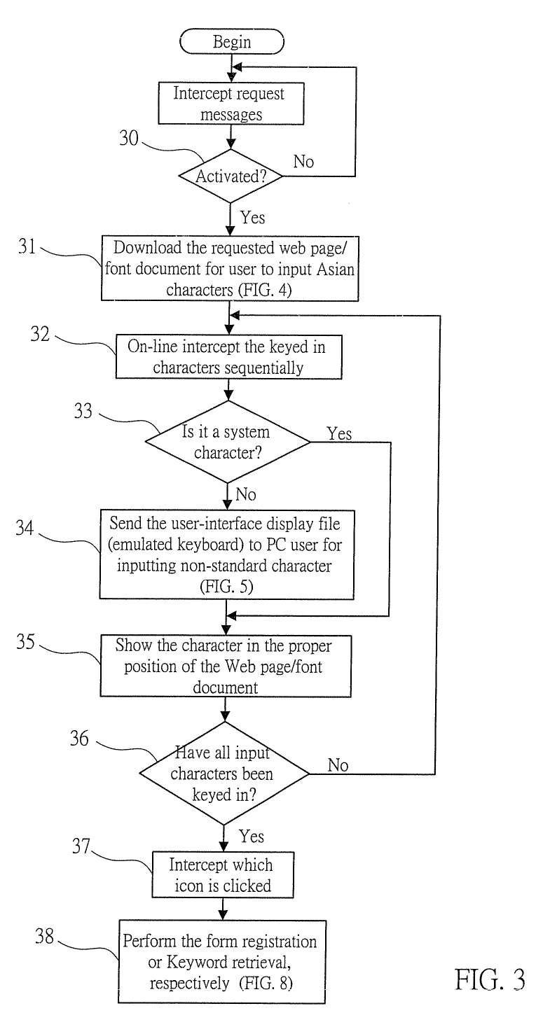

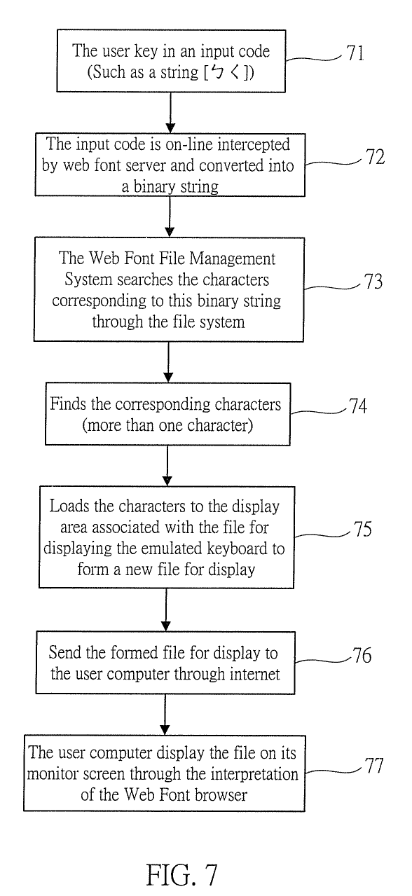

FIG. 2 shows a sample Web font file management system 60 included in the Web font server 24 of FIG. 1. The Web font file management system 60 generally includes Web font data manipulation software 61, which communicates with and/or controls a file system module 62, a character-codes-for-Asian-characters module 63, a font data types module 64, an Asian input methods module 65, a user-interface displays module 66, and a dynamic linking library module 67. Briefly, the file system module 62 organizes and controls various files used in the Web font file management system 60, the character codes for Asian characters module 63 stores character codes for various characters, the font data types module 64 stores various font data types of characters, the Asian input methods module 65 stores one or more Asian-language input methods (e.g., the Chinese phonetic input method), the user-interface displays module 66 stores one or more user-interface displays corresponding to the one or more Asian-language input methods, respectively, and the dynamic linking library module 67 controls various function calls. The function of the Web font data manipulation software 61, in conjunction with the modules 62-67, will be described in reference to the flowchart of FIGS. 3 and 7 below.

FIG. 3 is a flowchart illustrating a sample process to be performed generally by the Web font file management system 60 (and by the Web font browser 28), so as to permit the Web font browser 28 on the client computer 10 to retrieve non-standard characters to thereby allow a user to type in and display the retrieved non-standard characters on the display 15. The process starts with the Web font file management system 60 intercepting request messages that the client computer 10 has sent to the Web server 21. The request messages generated by the Web font browser 28 generally include four types of requests: to view an Asian Web font document; to download an Asian Web font document; to enter characters or other data into the downloaded Web font document; and/or to activate icons to perform various tasks.

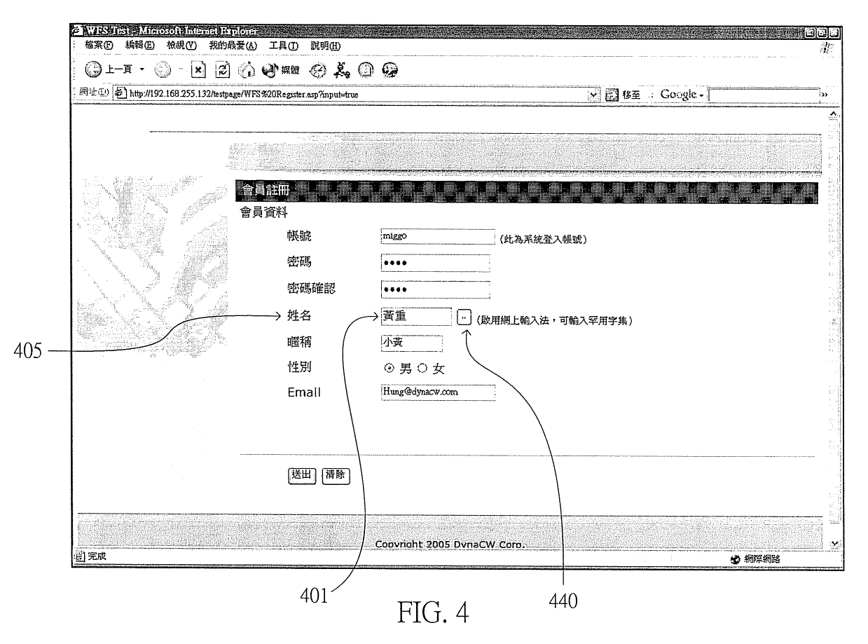

For example, FIG. 4 shows a downloaded Asian Web font document on a client computer, which prompts a user to type in his/her “name” 405 in a box for the purpose of membership registration. In the illustrated example, the user has entered two standard Chinese characters 401 in the box for “name” 405 using standard input means (e.g., a keyboard), and the user now needs to enter a third, non-standard character that is not supported by the client computer 10. The user then activates (e.g., clicks on) a non-standard character retrieval icon 440.

Referring back to FIG. 3, at block 30, if it is determined that a request to type in non-standard characters in a downloaded Web font document has been received (e.g., the non-standard character retrieval icon 440 has been “activated”), the process proceeds to a block 31 and the Web font file management system 60 first ensures that the requested Web font document, into which non-standard characters are to be input, is downloaded to the client computer 10. (In the illustrated embodiment of FIG. 4, the requested Web font document has already been downloaded by the time the user activated the non-standard character retrieval icon 440).

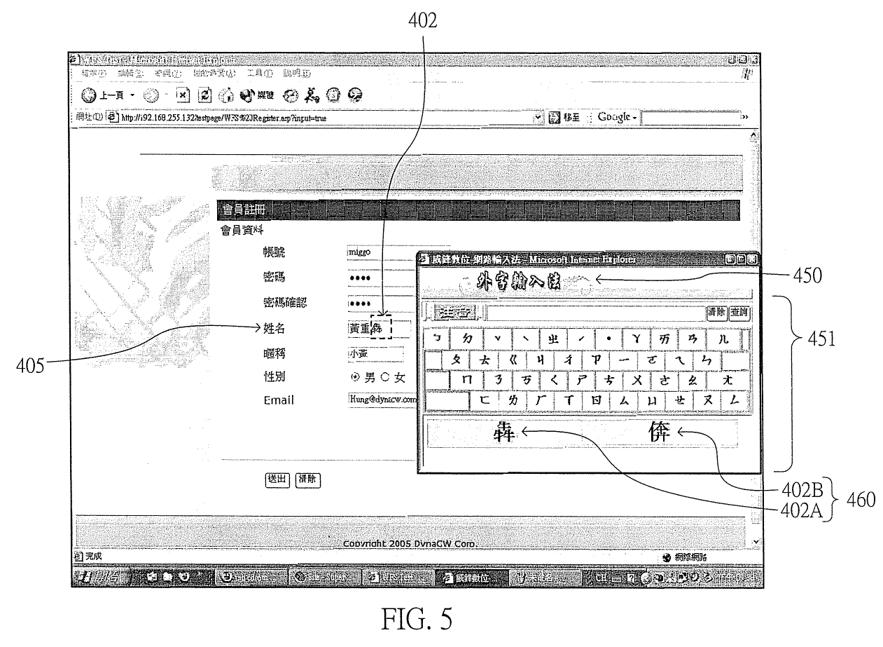

At a block 32, the Web font file management system 60 intercepts typed-in characters sequentially. Specifically, at a block 33, the Web font file management system 60 determines whether each of the typed in characters is a standard character (or a “system character”) supported by the Web font browser 28 of the client computer 10. If YES, proceeding to a block 35, the character that is typed in via standard input means (e.g., a keyboard) is displayed in the proper position (e.g., in the box for “name” 405 in FIG. 4) of the downloaded Web font document. If, at block 33, it is determined that the character is a non-standard character, at a block 34 the Web font file management system 60 sends a user-interface display file (e.g., an HTML file) containing an emulated keyboard 450 (FIG. 5) to the client computer 10. The user of the client computer 10 uses the emulated keyboard 450 to enter a non-standard character code for the desired non-standard character. For example, the emulated keyboard 450 may be the Chinese phonetic input keyboard 451 or a Roman language-based phonetic input keyboard (not shown), and the user may phonetically enter a sound of the desired non-standard character as the non-standard character code for the desired non-standard character, for example by clicking on the desired keys on the emulated keyboard 450.

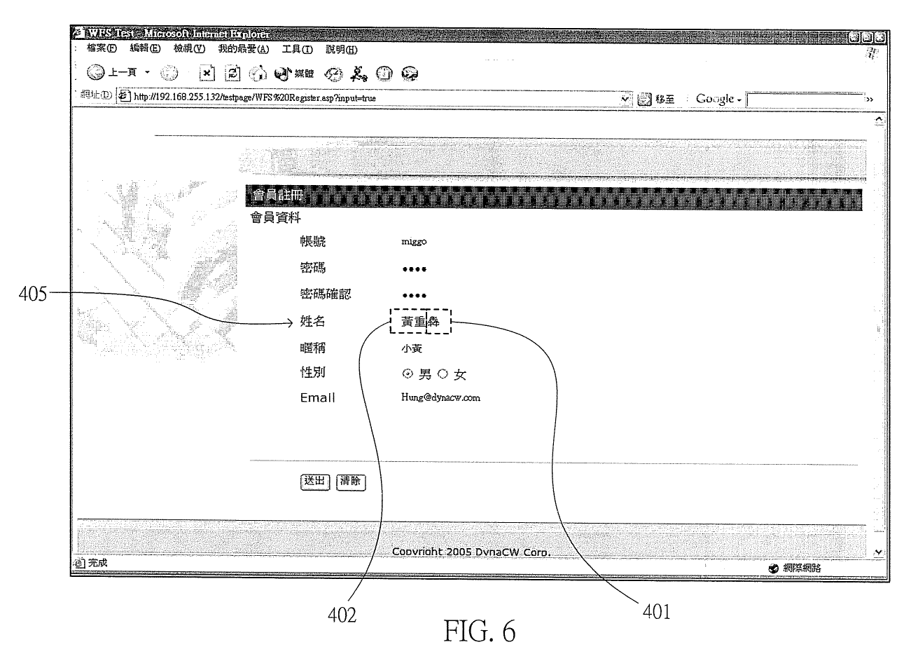

Oftentimes, there are two or more characters that phonetically match the sound entered by a phonetic input keyboard. In the illustrated example of FIG. 5, two such characters 402A and 402B have been identified in the Web font database 26 (FIG. 1) returned via a display area 460, in response to the user's phonetic input. In the example of FIG. 5, the user has then selected the character 402A as the desired character, for example by clicking on the character 402A. Thus, the character 402A is displayed as the character 402 in the box for “name” 405 next to the previously entered two standard characters 401. In some embodiments of the present invention, the emulated keyboard 450 may automatically disappear upon the user's selection/entry of the last non-standard character. FIG. 6 is a sample Web font document of FIGS. 4 and 5, in which the user “name” 405 has been fully entered to include the two standard characters 401 and one non-standard character 402.

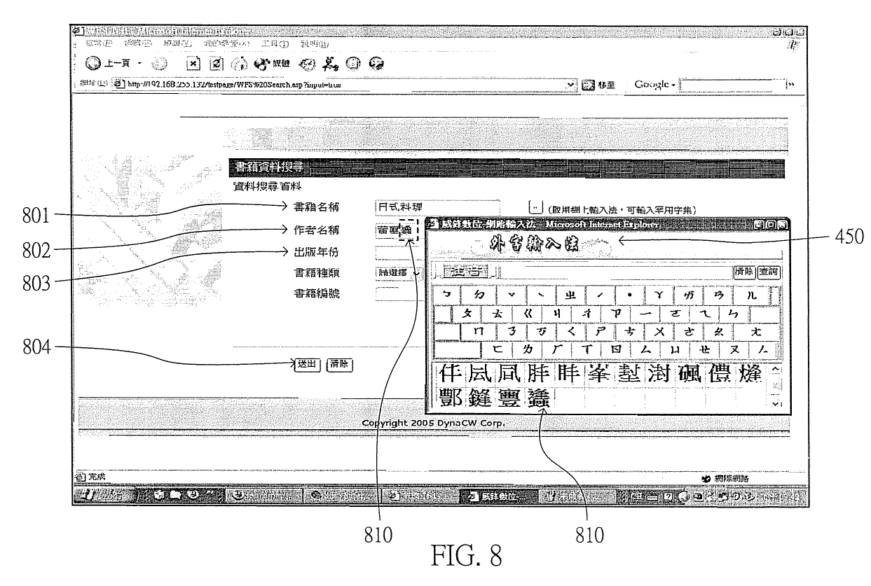

Referring back to FIG. 3, after the character entered by the user has been shown in the proper position on the Web font document at block 35, at a block 36, it is determined whether all input characters have been typed in. If not, the process returns to the box 32 and again intercepts the typed-in character. If, on the other hand, all input characters have been typed in, then at a block 37, the Web font file management system 60 intercepts what request icon has been selected by the user. For example, the user may have selected an icon to complete the membership registration process as shown in the example of FIGS. 4-6. Then, at a block 38, the Web file management system 60 sends the completed Web font document, i.e., a completed membership registration form in this case, to the Web server 21 to thereby complete the requested registration process. As another example, at block 37, the user may have selected an icon to perform a search to retrieve any Web font documents including the typed in non-standard character(s) as a keyword. If so, at block 38, the process performs the search to return any Web font documents including the typed-in non-standard character(s) as a keyword. FIG. 8 is a sample screen display to search for books based on keywords such as title 801, author 802, year of publication 803, etc. Upon user entry of the author's name including a non-standard character 810 via an emulated keyboard 450, when the user selects a “search” icon 804, the process performs the requested search to identify and return any Web font documents matching the user's entry of the title 801 and author 802.

FIG. 7 is a flowchart illustrating a sample process for inputting a non-standard character code for a non-standard character according to the Chinese phonetic input method. The process of FIG. 7 is generally performed by the Web font file management system 60 (and the client computer 10). At a block 71, the user types in a phonetic input code selected from the Chinese phonetic input keyboard 451 (FIG. 5). At a block 72, the input code is then intercepted by the Web font server 24 and converted into a binary string. At a block 73, the Web font file management system 60 searches for the characters in the Web font database 26 (FIG. 1) corresponding to the binary string. At a block 74, the Web font file management system 60 finds all the corresponding characters, which may be more than one (e.g., the two candidate characters 402A and 402B in FIG. 5 correspond to a single non-standard character code that has been entered phonetically). Optionally, if the user has specified a specific font data type (e.g., font face, style, and size), the Web font file management system 60 may additionally find the corresponding characters in the specified font data type based on the information contained in the font data types module 64 (FIG. 2). At a block 75, the characters identified at block 74 are loaded to a display area (e.g., 460 in FIG. 5) of the HTML file for displaying the emulated keyboard, so as to form a new HTML file for displaying the identified characters in the designated display area adjacent to the emulated keyboard 451 (FIG. 5). At a block 76, the newly formed file is sent to the user's client computer for display, via the Internet. At a block 77, the Web font browser 28 interprets the newly formed file and displays it on the monitor screen of the client computer.

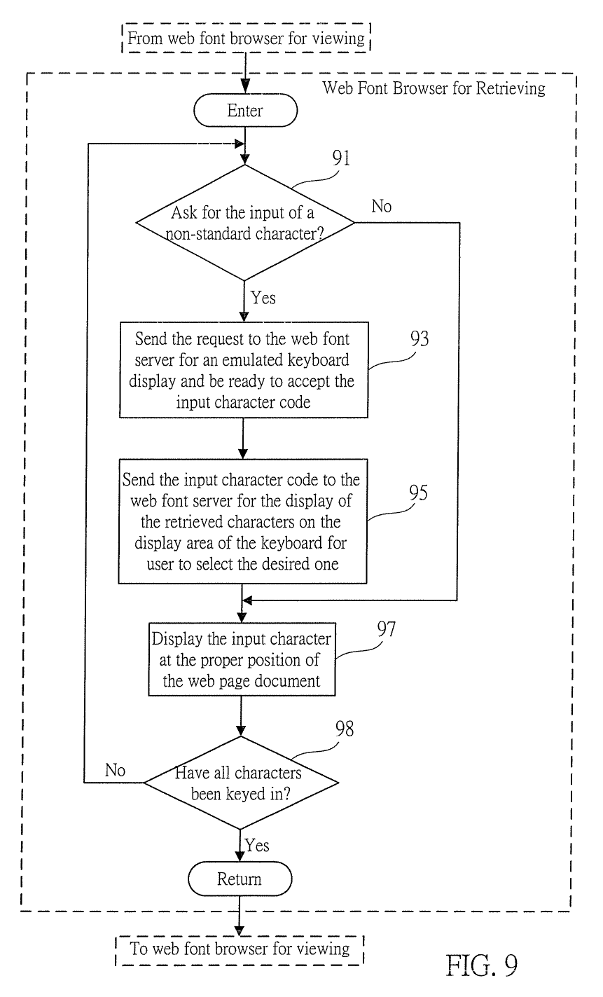

FIG. 9 is a flowchart illustrating a sample process to be performed by the Web font browser 28 operating in the client computer 10 for browsing Web font documents and for permitting the user to type in non-standard characters. In various exemplary embodiments of the present invention, the Web font browser 28 is a software product for on-line viewing of Web font documents from the Web server(s) 21 and for typing in non-standard characters into any downloaded Web font documents. The process starts with a block 91, where the Web font browser 28 determines whether the user has requested to type in a non-standard character (for example by clicking on the non-standard character retrieval icon 440 in FIG. 4). If NO, the character is a standard character supported by the client computer 10, and at a block 97, the Web font browser 28 displays the input character at the proper position of the Web font document. If, on the other hand, the user has requested to type in a non-standard character, then at a block 93, the Web font browser 28 sends a request to the Web font server 24 (see FIG. 1) for a user-interface display file (e.g., an HTML file) containing an emulated keyboard, and also enters into the mode of receiving the user input of non-standard character codes. At a block 95, the Web font browser 28 sends an input non-standard character code to the Web font server 24, displays the retrieved characters corresponding to the input character code in the designated display area (e.g., 460 in FIG. 5) of the emulated keyboard, and receives a user selection of the desired character. At a block 97, the Web font browser 28 displays the input character (which has been further confirmed to be the desired one in the step 95 above) at the proper position of the Web font document. At block 98, it is determined whether all characters have been typed in. If not, the process returns to the block 91.

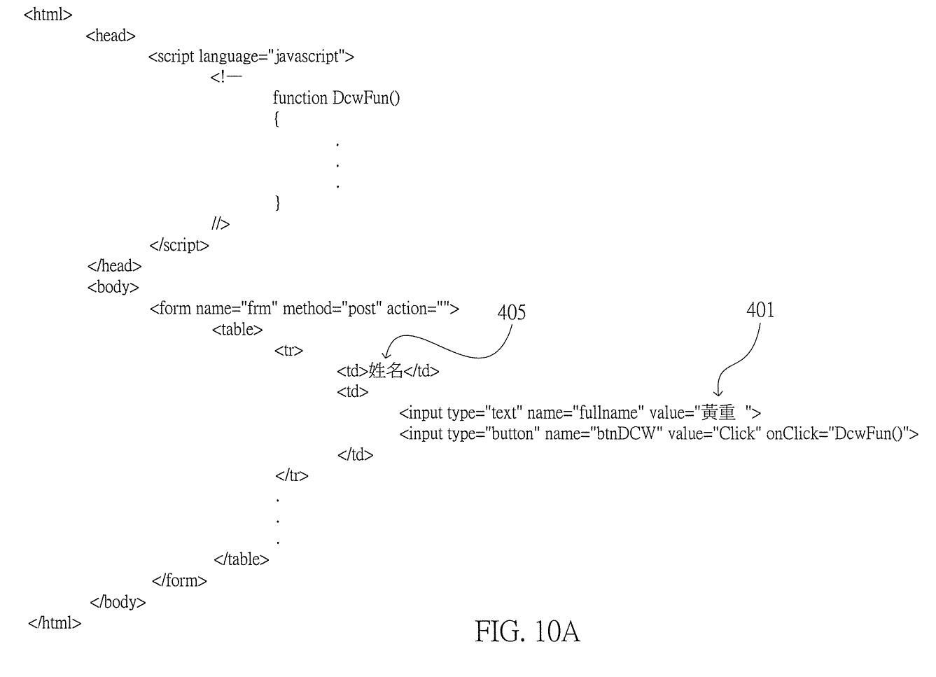

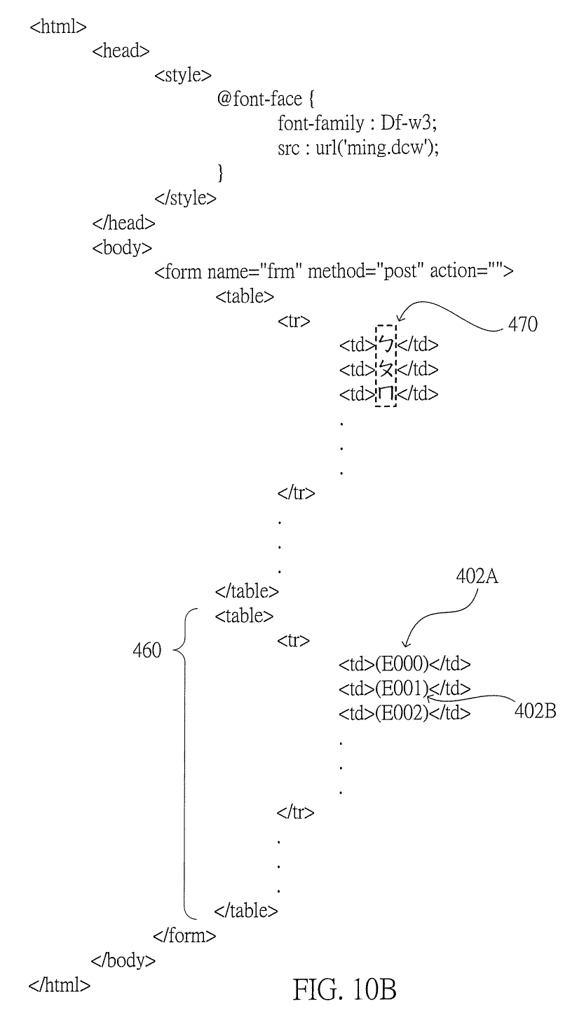

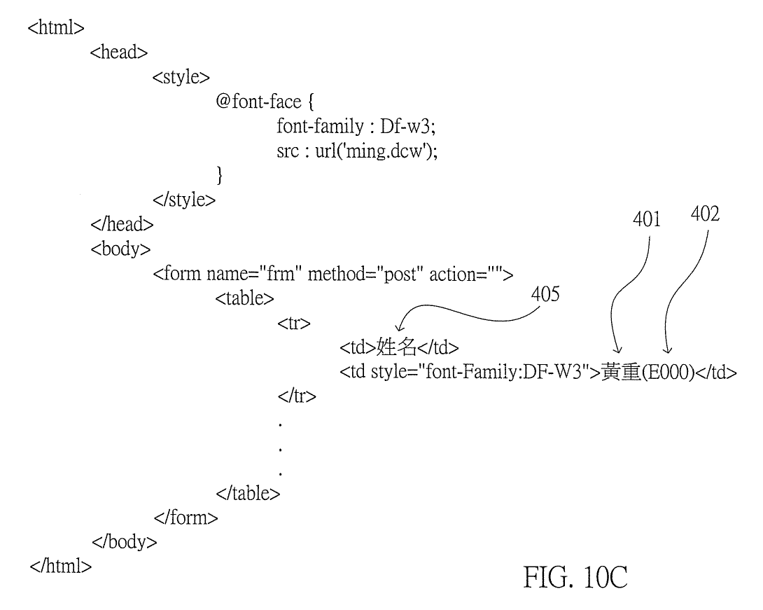

FIGS. 10A-10C are sample HTML files, which are created during various processes according to some embodiments of the present invention. FIG. 10A shows an HTML file corresponding to the display of FIG. 4, wherein two standard characters 401 have been entered into the box for “name” 405. Note that the HTML files of FIGS. 10A-10C show only the relevant character portions of the respective HTML files. FIG. 10B shows an HTML file corresponding to the display of FIG. 5, wherein the user has selected three keys 470 from the Chinese phonetic input keyboard 451 to phonetically enter a non-standard character code, which in turn has retrieved two non-standard characters 402A and 402B for selection by the user. FIG. 10C shows an HTML file corresponding to the display of FIG. 6, wherein the user has successfully entered his/her full name in the box for “name” 405, including the two standard characters 401 and the one non-standard character 402 selected by the user.

While the preferred embodiments of the invention have been illustrated and described, numerous variations in the illustrated and described arrangements of systems, components, and sequences of operations will be apparent to one skilled in the art based on this disclosure. Various aspects of the invention may be used separately, or in combinations, or in sequences other than those explicitly disclosed. Thus, it will be appreciated that various changes can be made therein without departing from the spirit and scope of the invention.

The embodiments of the invention in which an exclusive property or privilege is claimed are defined as follows:

1. A network-based method of permitting a user of a client computer to type in a non-standard character in a downloaded Web font document, the method comprising the steps of:
(a) receiving a user request to type in a non-standard character in a Web font document downloaded to the user's client computer;
(b) sending a user-interface display file comprising an emulated keyboard to the client computer;
(c) receiving a user-input non-standard character code that has been entered by the user via the emulated keyboard;
(d) identifying one or more non-standard characters corresponding to the user-input non-standard character code; and
(e) including the one or more non-standard characters in a file and sending the file to the client computer for display.

2. The network-based method of claim 1, wherein the user-interface display file comprises an emulated keyboard based on a phonetic input method.

3. The network-based method of claim 1, wherein the user-input non-standard character code comprises a phonetic character code.

4. The network-based method of claim 1, wherein step (d) comprises identifying one or more non-standard characters as being stored in a database.

5. The network-based method of claim 1, further comprising:
(f) receiving a user selection of one of the one or more non-standard characters displayed on the client computer; and
(g) causing the client computer to display the user-selected non-standard character.

6. A network-based system of permitting a user of a client computer to type in a non-standard character in a downloaded Web font document, the system comprising:
(a) a Web server connected to a network, the Web server supporting a Web font document; and
(b) a Web font server connected to the network for permitting a user of a client computer to type in a non-standard character in a Web font document downloaded from the Web server, the Web font server comprising a Web font database including Web font characters, wherein the Web font server further comprises:
(i) means for receiving a user request to type in a non-standard character in a Web font document downloaded to the user's client computer;
(ii) means for sending a user-interface display file comprising an emulated keyboard to the client computer;
(iii) means for receiving a user-input non-standard character code that has been entered by the user via the emulated keyboard;
(iv) means for identifying one or more non-standard characters in the Web font database which correspond to the user-input non-standard character code; and
(v) means for including the one or more non-standard characters in a file and sending the file to the client computer for display.

7. The network-based system of claim 6, wherein the user-interface display file comprises an emulated keyboard based on a phonetic input method.

8. The network-based system of claim 6, wherein the user-input non-standard character code comprises a phonetic character code.

9. The network-based system of claim 6, wherein the Web font server further comprises:
(vi) means for receiving a user selection of one of the one or more non-standard characters displayed on the client computer; and
(vii) means for causing the client computer to display the user-selected non-standard character.

10. A computer-readable tangible medium comprising computer-executable instructions which, when loaded onto a Web font server, cause the Web font server to perform the steps of:
(a) receiving a user request to type in a non-standard character in a Web font document downloaded to the user's client computer;
(b) sending a user-interface display file comprising an emulated keyboard to the client computer;
(c) receiving a user-input non-standard character code that has been entered by the user via the emulated keyboard;
(d) identifying one or more non-standard characters corresponding to the user-input non-standard character code; and
(e) including the one or more non-standard characters in a file and sending the file to the client computer for display.

11. The computer-readable tangible medium of claim 10, wherein the user-interface display file comprises an emulated keyboard based on a phonetic input method.

12. The computer-readable tangible medium of claim 10, wherein the user-input non-standard character code comprises a phonetic character code.

13. The computer-readable tangible medium of claim 10, further comprising computer-executable instructions which, when loaded onto the Web font server, cause the Web font server to perform the steps of:
(f) receiving a user selection of one of the one or more non-standard characters displayed on the client computer; and
(g) causing the client computer to display the user-selected non-standard character.

14. A computer-readable tangible medium comprising a computer-executable browser program for permitting a user of a client computer on which the browser program is operating to type in a non-standard character in a downloaded Web font document, the browser program comprising:
means for receiving a user request to enter a non-standard character and sending the request to a Web font server;
means for interpreting a user-interface display file comprising an emulated keyboard received from the Web font server and displaying the emulated keyboard on the client computer;
means for receiving a user-input non-standard character code via the displayed emulated keyboard;
means for sending the user-input non-standard character code to the Web font server; and
means for receiving one or more non-standard characters corresponding to the user-input non-standard character code from the Web font server and displaying the same on the client computer.

15. The computer-readable tangible medium of claim 14, wherein the one or more non-standard characters corresponding to the user-input non-standard character code are received in a file sent from the Web font server.

16. The computer-readable tangible medium of claim 14, wherein the browser program further comprises:
means for receiving a user selection of one of the one or more non-standard characters displayed on the client computer; and
means for displaying the user-selected non-standard character on the client computer.

17. The computer-readable tangible medium of claim 14, wherein the user-interface display file comprises an emulated keyboard based on a phonetic input method.

18. The computer-readable tangible medium of claim 14, wherein the user-input non-standard character code comprises a phonetic character code.

19. The computer-readable tangible medium of claim 14, wherein the means for receiving a user request to enter a non-standard character comprises a clickable icon.
